(19) United States
(12) Patent Application Publication
(10) Pub. No.: US 2010/0274384 A1
(43) Pub. Date: Oct. 28, 2010

(54) CONTINUOUS ROLL WIPE MATERIAL DISPENSER

(75) Inventors: Cecilia Nordlund, Molndal (SE); Karoline Pettersson, Lulea (SE)

Correspondence Address: YOUNG & THOMPSON, 209 Madison Street, Suite 500, Alexandria, VA, 22314, US

(73) Assignee: SCA HYGIENE PRODUCTS AB, Goteborg (SE)

(21) Appl. No.: 12/809,628

(22) PCT Filed: Dec. 21, 2007
(86) PCT No.: PCT/SE2007/001168

§ 371 Date: Jun. 21, 2010

(51) Int. Cl. G06F 17/00; A47K 10/28

(52) U.S. Cl. 700/240; 312/34.9; 312/34.11; 312/34.12

(57) ABSTRACT

A continuous roll wipe material dispenser includes an upper module containing elements for mounting a rotatable roll of clean wipe material within the upper module and a lower module containing elements for receiving used wipe material within the lower module. The upper module is vertically spaced from the lower module thereby exposing between the modules a length of wipe material extending from the clean wipe material roll. The dispenser has a sensor element for detecting a user's hand approaching the exposed wipe material. A first driving element operates in response to the sensor element for dispensing a predetermined length of clean wipe material from the upper module. A second driving element operates in response to the dispensing of wipe material, in order to take up a predetermined length of used wipe material from between the modules each time a length of clean wipe material has been dispensed.

### TECHNICAL FIELD

The present invention relates generally to continuous roll wipe material or towel dispensers and, more particularly, to continuous roll towel dispensers adapted for automatic dispensing of clean wipe material from a supply roll contained in a separate module.

### BACKGROUND ART

Conventional continuous roll towel dispensers will as a rule comprise a wall mounted housing from which a stretched length or a loop of textile towel is presented to a user. The user is required to grip the towel, preferably at both edges and pull a predetermined length of towel from a supply roll. After a predetermined time delay, which is selected to give the user sufficient time to dry both hands, the length of used towel is withdrawn by rolling it onto a used towel roll in the said housing. Often, the clean roll and the used roll are only separated by an internal wall inside the housing.

One object of the present invention to provide an improved continuous roll towel dispenser which completely separates the clean towel roll from the used towel roll so that the clean towel cannot be contaminated by the used towel. A related object of the invention is to provide such an improved continuous roll towel dispenser which separates the clean towel roll and the used towel roll and yet is relatively compact.

U.S. Pat. No. 3,574,431 discloses a modular dispenser with a conventional function, wherein the web material is presented to the user as a flat web and is pulled out manually from a first module by the user. The used web is withdrawn automatically by a second module after a pre-set time delay. This dispenser solves the problem of maintaining the supply roll and used roll separated, but requires the user to withdraw the towel. If a user pulls the towel excessively or attempts to withdraw an additional amount of towel, then the mechanism may be damaged. Also, if the towel is drawn out at an angle that does not coincide with the longitudinal direction of the towel, then the towel may become bunched up and block the feeding mechanism. In both cases, the dispenser will become inoperative until it can be serviced.

A further solution is disclosed DE 203 09 309, showing a modular dispenser where the supply roll and used roll are kept separated. In this case, the web is preferably arranged at right angles to the user. The dispenser is arranged to maintain the exposed length of towel in a stretched position during use. When it is detected that the exposed length of material has been used, a fresh length of material is fed forward. A problem with this dispenser is that the user may attempt to withdraw an additional length of towel, as this would be the common procedure for a standard continuous roll towel dispenser. Furthermore, a user may not feel comfortable with drying his/her hands on a flat, stretched length of material, which could also cause the user to try and withdraw an additional length of towel. Again, an excessive force applied to the feeding mechanism may cause damage to the mechanism. With the towel presented to the user edge on, there is also a high probability that the force will be applied at an angle and cause the mechanism to malfunction, as described above.

Hence a further object of the invention is provide an improved continuous roll towel dispenser which provides the user with a sufficient length of towel while avoiding the risk of the mechanism being subjected to excessive force.

### DISCLOSURE OF INVENTION

The above problems have been solved by a dispenser and a method for controlling said dispenser according to the appended claims.

According to a preferred embodiment, the invention relates to a dispenser for a continuous roll of wipe material, which dispenser comprises the combination of an upper module containing means for mounting a rotatable roll of wipe material within said upper module, a lower module containing means for receiving used wipe material within said lower module, said upper module being vertically spaced from the lower module so that a length of wipe material extending as a substantially flat web from said clean wipe material roll is exposed between said modules. In the subsequent text, the term “dispenser” is used for the entire arrangement comprising at least an upper and a lower module.

The dispenser is provided with sensor means for detecting a user's hand approaching the exposed length of wipe material. The sensor means may comprise one or more infra red (IR) sensors, radio frequency disruption sensors, capacity sensors, motion or light detectors, photoelectric cells, proximity detectors or any other suitable type of contactless sensor. Here, the term “sensor means” is used for a sensor array comprising at least one sensor unit. In order to ensure detection of an object such as the hand(-s) of a user, the sensor means may comprise sensor units located at least along a lower edge, or similar, of the upper module. If it is desired to cover objects approaching the exposed wipe material from the sides of the upper module, additional sensor units may be located at the lower end of the side surfaces of the upper module. A first driving means is arranged to be operated in responsive to the sensor means for dispensing a predetermined length of wipe material from said clean wipe material roll in said upper module. The length of material will form a loop suspended from the upper module and will be sufficiently long to allow the user to grasp the wipe material and dry both hands. A second driving means is arranged to be operated in response to the dispensing of wipe material, in order to take up a predetermined length of used wipe material from between the modules each time a length of clean wipe material has been dispensed from said clean wipe material roll. The second driving means may be controlled by a control means to withdraw the used wipe material until a predetermined resistance or tension is sensed or detected and the exposed length of clean wipe material is stretched between the two modules. The length of material to be dispensed and withdrawn may be varied depending on the distance between the dispensers and other parameters that may be set by the supplier of the dispenser to achieve certain functions. For instance, for a dispenser having the modules mounted to provide an exposed length of 30-40 cm, the control means may actuate the first driving means to supply a user with 40 cm of clean wipe material. When the user has wiped his hands, the second driving means will be actuated to withdraw the used wipe material. In order to ensure that there is no overlap of used section of wipe material, the first driving means may at the same time be actuated to dispense a further 10-15 cm of clean wipe material. The total length of wipe material used during each such operating cycle will then be 50-55 cm.

In order to control the operation of the dispenser it may be provided with a control means interconnecting said first and second driving means to automatically drive said second driving means to withdraw said length of used wipe material in response to operation of said first driving means after the dispensing of wipe material from said clean wipe material roll. The dispensing operation may be actuated when a hand triggers a sensor as the user reaches out to grasp the wipe material. The sensors may have a sensor field extending downwards and outwards from at least the front of the upper module. As the hands of the user may approach the edges of the wipe material from either side of the dispenser, the sensor field may also extend downwards and outwards from the sides of the upper module. The range of the sensor field is preferably chosen so that the dispensing of clean wipe material is started before the user has gripped the side edges thereof. Withdrawal of the used length of material may be actuated after a predetermined time delay, where a counter may be triggered following the start or the end of the dispensing operation. Alternatively, the withdrawal function may be actuated when the sensors indicate that the hands of the user have been removed out of the range of the sensor field of the at least one sensor.

The lower module may contain means for mounting a rotatable roll for receiving used wipe material, in which case the second driving means will act on the used roll. Alternatively, the second drive means may be arranged to draw the used wipe material into the lower module, where after the material is merely collected in the said module. The dispenser may use webs comprising tissue material, non-woven material and textile material. Examples of suitable materials are, for instance, a reinforced tissue paper comprising a polymer net having outer plies of tissue paper, or a web comprising a mixture of non-woven and tissue paper.

In order to allow the user to access the wipe material freely, the upper and lower modules may be arranged to space the exposed length of wipe material a predetermined distance away from a common surface, such as a wall. The modules are preferably mounted so that both side edges of the exposed length of wipe material are readily accessible to the user. Instead of being mounted directly on a wall or a similar surface, the upper and lower modules may be mounted on a common rear panel.

The upper module may be provided with an elongated wipe material egress slot or dispensing opening at a lower surface or a lower front corner of the module, which dispensing opening may extend along a major part of the width of the module. Similarly, the lower module may be provided with an elongated wipe material ingress slot or opening at an upper surface or an upper front corner of the lower module, so that the exposed length of wipe material between said egress and ingress slots is presented substantially distanced from the module surfaces. In this way the user may grasp the exposed length of wipe material without coming into contact with either of the modules, an optional rear panel connecting the modules or the wall surface onto which the dispenser modules are mounted.

In order to ensure that the length of dispensed wipe material forms a loop in front of and towards the user, the material ingress slot in the lower module should preferably, but not necessarily, be located behind a vertical plane through the egress slot in the upper module. In this way the vertical plane through the egress slot is located between the ingress slot and the user. Hence, if the modules are mounted on a vertical wall then the material ingress slot is preferably located closer to the wall than the egress slot. The egress and ingress slot may be allowed to be placed in the same vertical plane if the upper surface of the lower module is arranged angled downwards and outwards relative to the wall. This arrangement would ensure that the weight of the dispensed wipe material causes the web to form a loop in front of and towards the user. According to one example, the wipe material may extend from the lower front corner of the upper module towards the front corner of the upper module. In this way the exposed wipe material may extend in a substantially vertical plane between the modules. According to a further example, the wipe material may extend from the lower front corner of the upper module towards the upper surface of the lower module. In this way the exposed wipe material may extend in a plane angled inwards and downwards between the modules. Each of said upper and lower modules enclose said wipe material rolls and include an at least partially removable section for providing access to the respective roll of wipe material, that is to re-fill the upper module and empty the lower module.

According to a first alternative embodiment, the first driving means includes a pair of driven rollers in said upper module arranged to frictionally engage said wipe material for dispensing a predetermined length thereof. According to a second alternative embodiment, the first driving means includes a driven roller in said upper module arranged to frictionally engage said wipe material roll for dispensing a predetermined length thereof. According to a third alternative embodiment, the first driving means includes a motor for driving the clean wipe material roll in said upper module for dispensing a predetermined length of said wipe material.

According to a fourth alternative embodiment, the second driving means includes a pair of rollers in said lower module arranged to frictionally engage the used wipe material to withdraw the dispensed length of wipe material into the second module. According to a fifth alternative embodiment, the second driving means includes a driven roller in said lower module arranged to frictionally engage the used wipe material roll to withdraw the dispensed length of wipe material into the second module. According to a sixth alternative embodiment, the second driving means includes a motor for driving the used wipe material roll for winding the dispensed length of wipe material onto the used wipe material roll in the second module. The above embodiments relating to the second drive means may be combined with any one of the embodiments relating to the first drive means.

According to a further embodiment, the invention relates to a method for controlling a continuous roll wipe material dispenser as described above. The method may comprise the steps of
monitoring a first condition, indicating the presence of an object approaching an exposed length of wipe material, and when the first condition is fulfilled;
initiating a first drive means and dispensing a predetermined length of wipe material from a first module,
monitoring a second condition, indicating the absence of the user and/or the expiry of a predetermined period of time, indicative of the wipe material having been used by a user, and when the second condition is fulfilled;
initiating a second drive means and withdrawing the predetermined length of wipe material into a second module.

The presence of an object approaching the exposed length of wipe material may be determined by monitoring an output signal from a sensor means, wherein the first condition is fulfilled when the said object is inside the range of the sensor means. Suitable sensor means for this purpose and the arrangement of sensor units of such a sensor means have been described in the above text.

According to a first example, the condition indicative of the wipe material having been used by a user may be determined by monitoring a time period after initiation of the first drive means. In this case, the second condition is fulfilled upon expiry of a predetermined period of time.

According to a second example, the condition indicative of the wipe material having been used by a user may be determined by monitoring an output signal from a sensor means, wherein the second condition is fulfilled when the said object is outside the range of the sensor means. This indicates the absence of the user. In order to ensure that the used wipe material is withdrawn within a reasonable period of time, this example may be combined with the first example. This function may be used in case of a sensor malfunction, or if one or more sensors have been incapacitated or blocked. The period of time monitored in the second example may be the same or longer than that of the first example.

### BRIEF DESCRIPTION OF DRAWINGS

The invention will be described in detail with reference to the attached figures. It is to be understood that the drawings are designed solely for the purpose of illustration and are not intended as a definition of the limits of the invention, for which reference should be made to the appended claims. It should be further understood that the drawings are not necessarily drawn to scale and that, unless otherwise indicated, they are merely intended to schematically illustrate the structures and procedures described herein.

FIG. 1 shows a schematic illustration of a dispenser according to one embodiment of the invention;

FIG. 2 shows a schematic illustration of according to an alternative embodiment of the invention;

FIG. 3 shows a schematic illustration of according to an alternative embodiment of the invention; and

FIG. 4 shows a schematic illustration of according to an alternative embodiment of the invention.

### EMBODIMENTS OF THE INVENTION

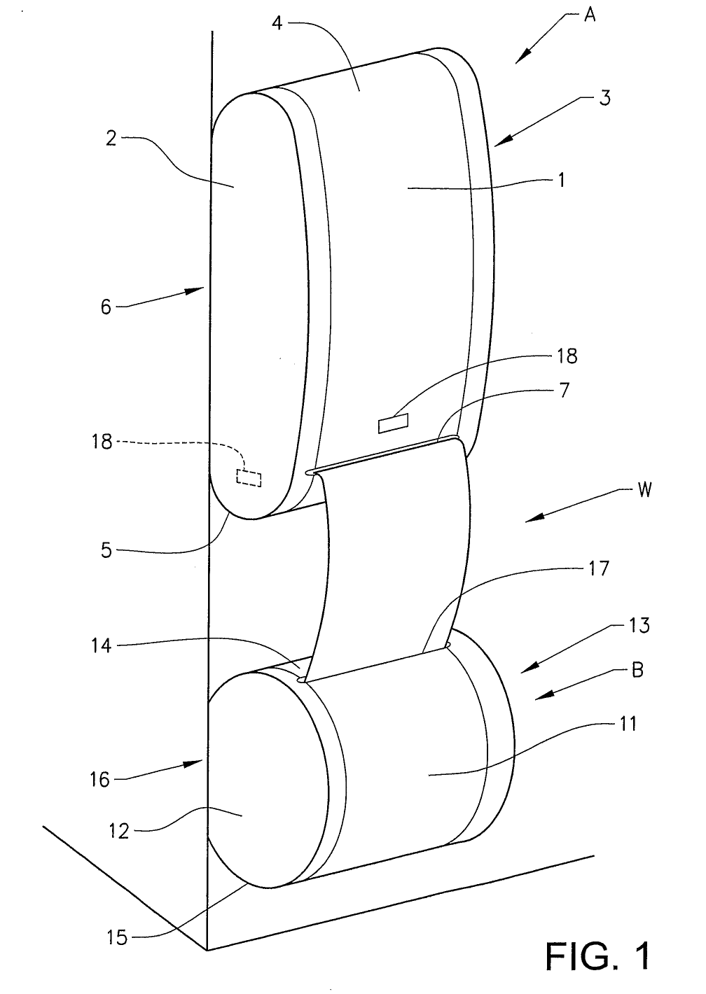

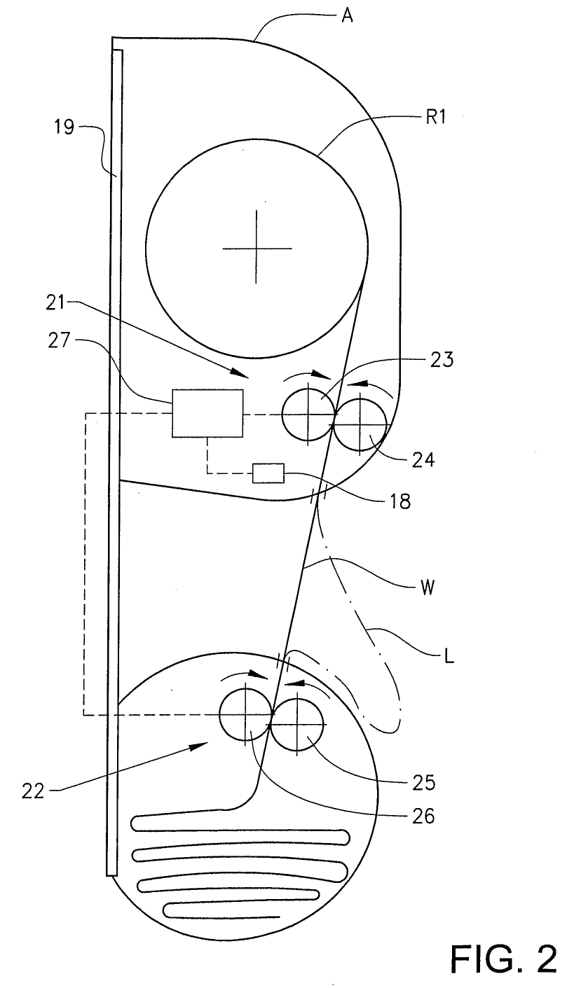

FIG. 1 shows a schematic illustration of a dispenser according to one embodiment of the invention. The figure shows a dispenser comprising combination of an upper module A containing means for mounting a rotatable roll of wipe material within said upper module A and a lower module B containing means for receiving used wipe material within the lower module B. The upper module A comprises a front cover 1, a pair of side walls 2, 3, an upper section 4, a lower section 5 and a rear section 6 (see FIG. 2), which rear section 6 is adapted for mounting on a wall or a similar surface. A dispenser opening 7 in the shape of an elongated slot is arranged along the lower, front portion of the upper module A, in an area where the front cover 1 joins the lower section 5.

Similarly, The lower module B comprises a front cover 11, a pair of side walls 12, 13, an upper section 14, a lower section 15 and a rear section 16 (see FIG. 2), which rear section 16 is adapted for mounting on a wall or a similar surface below the upper module A. A receiving opening 17 in the shape of an elongated slot is arranged along the upper, front portion of the lower module B. The receiving opening 17 can be located in a substantially vertical plane between a substantially vertical plane through the dispensing opening 7 and the rear section 16. The receiving opening 17 can be placed substantially directly below the dispensing opening 7, but is preferably located so that a length of wipe material W extending between the openings is arranged at an angle downwards and inwards from the dispenser opening 7. The upper and lower modules A, B can be mounted directly on a wall or a similar surface, as shown in FIG. 1, or be mounted on a common rear panel (see FIG. 2). Alternatively, a separate spacing panel can be mounted on the wall between the upper and lower modules to ensure a desired spacing and to facilitate relative positioning of the modules during mounting. Each of said upper and lower modules enclose said wipe material rolls and include at least one partially removable section for providing access to the respective roll of wipe material, that is to re-fill the upper module A and empty the lower module B.

The upper module A is vertically spaced from the lower module so that a length of wipe material W extending as a substantially flat web from said clean wipe material roll is exposed between said modules. In order to allow the user to access the wipe material freely, the upper and lower modules A, B are also arranged to space the exposed length of wipe material W a predetermined distance away from the surface, such as a wall, on which the modules are mounted. The modules are preferably mounted so that both side edges of the exposed length of wipe material are readily accessible to the user.

The dispenser is provided with sensor means 18 for detecting a user's hand approaching the exposed length of wipe material W. The sensor means 18 comprises at least one infra red (IR) sensor, or a similar suitable type of contactless sensor. In order to ensure detection of an object such as the hands of a user, the sensor means 18 comprises sensor units located at least along a lower edge, or similar, of the upper module A (one only is indicated in FIG. 1). Additional sensor units 18, indicated by dashed lines) can be located at the lower end of the side walls 2, 3 of the upper module A to detect objects approaching the exposed wipe material from the sides of the upper module A.

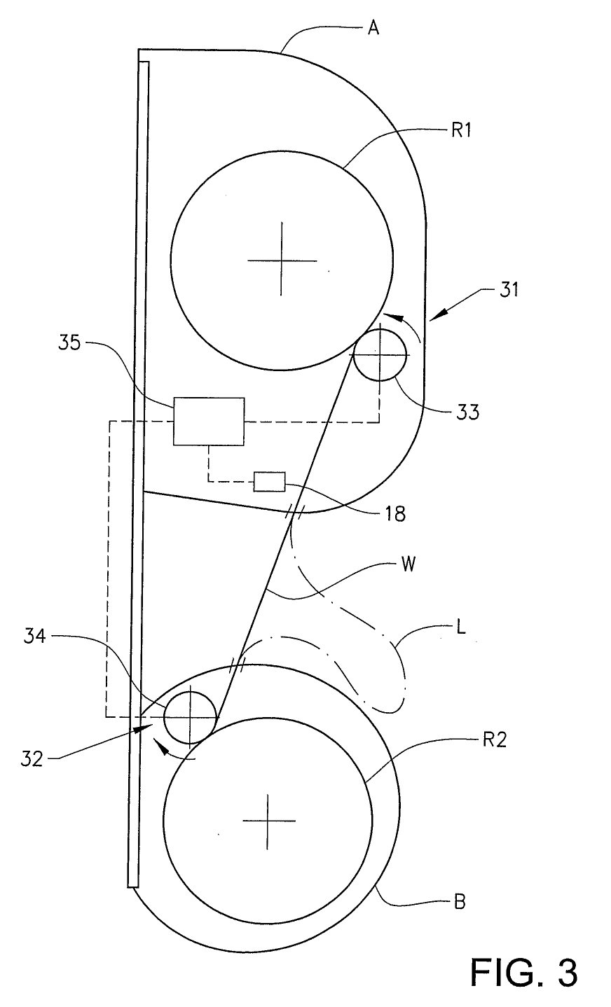

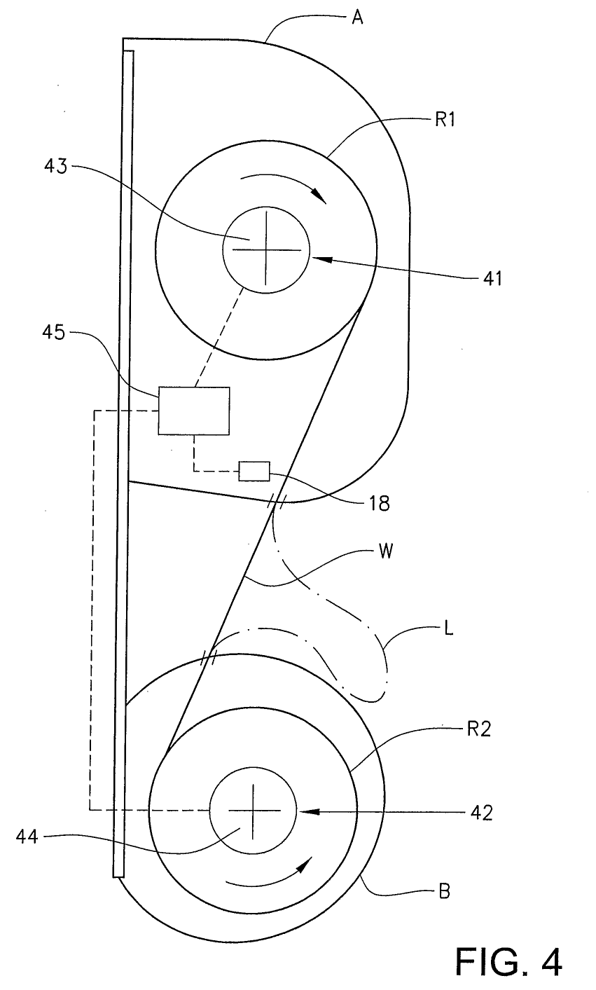

The operation of the dispenser will be described in detail in connection with the examples shown in the FIGS. 2-4 below. In all the examples, sensors in the upper module A of the dispenser are arranged to monitor a first condition, indicating the presence of an object, such as a hand, approaching the exposed length of wipe material W. When the first condition is fulfilled, a first driving means is arranged to be operated in responsive to the sensor means for dispensing a predetermined length of wipe material from said clean wipe material roll R1 in said upper module A. The length of material will form a loop L suspended from the upper module A and will be sufficiently long to allow the user to grasp the wipe material and dry both hands. A second driving means is arranged to be operated in response to the dispensing of wipe material, in order to take up a predetermined length of used wipe material from between the modules each time a length of clean wipe material has been dispensed from said clean wipe material roll R1.

For instance, for a dispenser having the modules mounted to provide an exposed length of 30-40 cm, the control means may actuate the first driving means to supply a user with 40 cm of clean wipe material. When the user has wiped his hands, the second driving means will be actuated to withdraw the used wipe material. In order to ensure that there is no overlap of used section of wipe material, the first driving means may at the same time be actuated to dispense a further 10-15 cm of clean wipe material. The total length of wipe material used during each such operating cycle will then be 50-55 cm.

An electronic control means 27, 35, 47 is arranged to monitor a second condition, which condition is indicative of the wipe material having been used by a user. According to a first example, the said second condition indicative of the wipe material having been used by a user may be determined by monitoring a time period after initiation of the first drive means. In this case, the second condition is fulfilled upon expiry of a predetermined period of time. According to a second example, the said second condition indicative of the wipe material having been used by a user may be determined by monitoring an output signal from a sensor means 18, wherein the second condition is fulfilled when the said object is outside the range of the sensor means 18.

The electronic control means interconnects said first and second driving means, to automatically drive said second driving means to withdraw said length of used wipe material in response to operation of said first driving means after the dispensing of wipe material from said clean wipe material roll. The dispensing operation may be actuated when a hand triggers a sensor as the user reaches out to grasp the wipe material. The sensors may have a sensor field extending downwards and outwards from at least the front of the upper module A. As the hands of the user may approach the edges of the wipe material from either side of the dispenser, the sensor field may also extend downwards and outwards from the sides of the upper module A. The range of the sensor field is preferably chosen so that the dispensing of clean wipe material is started before the user has gripped the side edges thereof. Withdrawal of the used length of material may be actuated after a predetermined time delay, where a counter may be triggered to monitor a first time period following the start of, or the end of, the dispensing operation. A suitable length of time for a first time period initiated at the start of the dispensing operating is approximately 5-10 seconds.

Alternatively, the withdrawal function may be actuated when the sensors indicate that the hands of the user have been removed out of the range of the sensor field of the at least one sensor. In order to safeguard that the wipe material is withdrawn, the withdrawal function may be actuated after a second period of time, which second time period is equal to or longer than the first period of time.

The lower module B may contain means for mounting a rotatable roll R2 for receiving used wipe material, in which case the second driving means will act on the used roll. Alternatively, the second drive means may be arranged to draw the used wipe material into the lower module B, where after the material is merely collected in the said module. The dispenser may use both textile and non-woven webs of material.

According to a first alternative embodiment shown in FIG. 2, the first driving means 22 comprises a first pair of driven rollers 23, 24 in said upper module A arranged to frictionally engage said wipe material for dispensing a length L thereof. The second driving means comprises a second pair of driven rollers 25, 26 in said lower module B arranged to frictionally engage the used wipe material to withdraw the dispensed length L of wipe material into the lower module B.

According to a second alternative embodiment, the first driving means 31 comprises a first driven roller 33 in said upper module A arranged to frictionally engage said wipe material roll for dispensing a length L thereof. The second driving means 32 comprises a second driven roller 34 in said lower module B arranged to frictionally engage the used wipe material roll to withdraw the dispensed length of wipe material into the lower module.

According to a third alternative embodiment, the first driving means 41 comprises a motor 43 for driving the clean wipe material roll R1 in said upper module A for dispensing a length of said wipe material. The second driving 42 means comprises a motor 44 for driving the used wipe material roll R2 for winding the dispensed length of wipe material L onto the used wipe material roll R2 in the lower module B.

The above alternative embodiments relating to the second drive means may be combined with any one of the embodiments relating to the first drive means.

The invention is not limited to the above examples, but may be varied freely within the scope of the appended claims.

1. A continuous roll wipe material dispenser comprising the combination of an upper module containing means for mounting a rotatable roll of wipe material within said upper module, a lower module containing means for receiving used wipe material within said lower module, said upper module being vertically spaced from the lower module so that a length of wipe material extending from said clean wipe material roll is exposed between said modules,
wherein the dispenser is provided with sensor means for detecting a user's hand approaching the exposed wipe material; a first driving means arranged to be operated in responsive to the sensor means for dispensing a predetermined length of wipe material from said clean wipe material roll in said upper module; and a second driving means arranged to be operated in response to the dispensing of wipe material, in order to take up a predetermined length of used wipe material from between the modules each time a length of clean wipe material has been dispensed from said clean wipe material roll.

2. The continuous roll wipe material dispenser according to claim 1,
wherein the lower module contains means for mounting a rotatable roll for receiving used wipe material.

3. The continuous roll wipe material dispenser according to claim 1,
wherein the second driving means is arranged to be operated after a predetermined period of time after the dispensing of wipe material from said clean wipe material roll.

4. The continuous roll wipe material dispenser according to claim 1,
wherein said upper and lower modules are arranged to space the exposed length of wipe material a predetermined distance away from a common surface on which said modules are mounted so that both side edges of the exposed length of wipe material are readily accessible to the user.

5. The continuous roll wipe material dispenser according to claim 4,
wherein said upper and lower modules are mounted on a common rear panel.

6. The continuous roll wipe material dispenser according to claim 4,
wherein said upper and lower modules are mounted as separate units on a wall surface.

7. The continuous roll wipe material dispenser according to claim 1,
wherein each of said upper and lower modules enclose said wipe material rolls and include an at least partially removable section for providing access to the wipe material rolls contained therein.

8. The continuous roll wipe material dispenser according to claim 1,
wherein said upper module comprises an elongated wipe material egress slot at the lower front corner thereof and said lower module comprises an elongated wipe material ingress slot at the upper front corner thereof so that the exposed length of wipe material between said egress and ingress slots is substantially distanced from the module surfaces.

9. The continuous roll wipe material dispenser according to claim 1,
wherein said lower module comprises an elongated wipe material ingress slot and said upper module comprises an elongated wipe material egress slot, and where a vertical plane through the egress slot is located between the ingress slot and the user.

10. The continuous roll wipe material dispenser according to any claim 1, wherein said first driving means includes a pair of driven rollers in said upper module arranged to frictionally engage said wipe material for dispensing a predetermined length thereof.

11. The continuous roll wipe material dispenser according to claim 1, wherein said first driving means includes a driven roller in said upper module arranged to frictionally engage said wipe material roll for dispensing a predetermined length thereof.

12. The continuous roll wipe material dispenser according to claim 1, wherein said first driving means includes a motor for driving the clean wipe material roll in said upper module for dispensing a predetermined length of said wipe material.

13. The continuous roll wipe material dispenser according to claim 10, wherein said second driving means includes a pair of rollers in said lower module arranged to frictionally engage the used wipe material to withdraw the dispensed length of wipe material into the second module.

14. The continuous roll wipe material dispenser according to claim 9, wherein said second driving means includes a driven roller in said lower module arranged to frictionally engage the used wipe material roll to withdraw the dispensed length of wipe material into the second module.

15. The continuous roll wipe material dispenser according to claim 9, wherein said second driving means includes a motor for driving the used wipe material roll for winding the dispensed length of wipe material onto the used wipe material roll in the second module.

16. The continuous roll wipe material dispenser according to claim 1,
wherein the dispenser is provided with control means interconnecting said first and second driving means to automatically drive said second driving means to withdraw said used wipe material roll in response to operation of said first driving means after the dispensing of wipe material from said clean wipe material roll.

17. The continuous roll wipe material dispenser according to claim 1,
wherein the sensor is a contactless sensor.

18. The continuous roll wipe material dispenser according to claim 17,
wherein the sensor is an infrared sensor.

19. The continuous roll wipe material dispenser according to claim 17,
wherein the sensor is an inductive sensor.

20. Method for controlling a continuous roll wipe material dispenser according to claim 1,
comprising the steps of
monitoring a first condition, indicating the presence of an object approaching an exposed length of wipe material, and when the first condition is fulfilled;
initiating a first drive means and dispensing a predetermined length of wipe material from a first module,
monitoring a second condition, indicating the absence of the user and/or the expiry of a predetermined period of time, and when the second condition is fulfilled; and
initiating a second drive means and withdrawing the predetermined length of wipe material into a second module.

21. Method according to claim 20, further comprising monitoring an output signal from a sensor means, wherein the first condition is fulfilled when the object is inside the range of the sensor means.

22. Method according to claim 20, further comprising monitoring a time period after initiation of the first drive means, wherein the second condition is fulfilled upon expiry of a predetermined first period of time.

23. Method according to claim 20, further comprising monitoring an output signal from a sensor means, wherein the second condition is fulfilled when the object is outside the range of the sensor means.

24. Method according to claim 23, further comprising monitoring a time period after initiation of the first drive means, wherein the second condition is fulfilled upon expiry of a predetermined second period of time, which second time period is equal to or longer than the first period of time.
